(19) United States
(12) Patent Application Publication
(10) Pub. No.: US 2010/0019488 A1
(43) Pub. Date: Jan. 28, 2010

(54) Hose Coupling with Flow Control

(76) Inventor: Norris R. Weimer, Cottonwood Heights, UT (US)

Correspondence Address: THORPE NORTH & WESTERN, LLP., P.O. Box 1219, SANDY, UT, 84091-1219, US

(21) Appl. No.: 12/510,420

(22) Filed: Jul. 28, 2009

Related U.S. Application Data
(60) Provisional application No. 61/083,986, filed on Jul. 28, 2008.

(51) Int. Cl. F16L 35/00; F16L 37/00; F16K 5/00; B23P 11/00

(52) U.S. Cl. 285/328; 285/18; 285/305; 251/304; 29/525.01

(57) ABSTRACT

A fluid-tight, quick-connect coupling for connecting two fluid transfer devices that comprises a male mating body inserted into a female sleeve body, and which can be locked into position with a locking mechanism. The coupling also comprises an in-line flow control mechanism wherein variable flow control can be achieved by operating the locking mechanism.

### RELATED APPLICATIONS

The present application claims the benefit of U.S. Provisional Patent Application No. 61/083,986, filed Jul. 28, 2008, which is incorporated herein by reference.

### FIELD OF THE INVENTION

This invention is generally related to garden hose connectors and flow control valves. Accordingly, the present invention involves the fields of gardening implements, fluid flow and mechanical engineering.

### BACKGROUND OF THE INVENTION

Traditional hose couplings employ a threaded connection between the hose end and its attachments, e.g. a threaded male connector on the hose end and a complementary threaded female connector on each attachment. For proper sealing, the inserted male connector typically must fit squarely against an annular seal in the female connector and be held rigidly in place. If the male connector wobbles or becomes canted inside the female connector, or if it is not held firmly in place, the coupling does not maintain uniform contact around the entire circumference of the gasket and the connection may leak.

These traditional threaded couplings depend only on the friction between the threads of the two connectors to maintain the connection, and because the sealing gasket itself is of minimum compressibility the connection is prone to loosen with a resultant spray of water and a wet, unhappy gardener. Moreover, threaded couplings can be difficult and time consuming to connect and disconnect and are further susceptible to cross-threading and stripped or damaged threads.

Existing quick-connect couplings, while serving only the purpose of a quick connect/disconnect feature, do not address the problems associated with threaded male to female connections. Most conventional quick-connects are generally variations of the same design, which use the same single annular seal or gasket of the standard threaded connection, i.e. one that is fitted into a pocket formed inside the female sleeve body, and which contacts and presses against the front axial face of the inserted male tubular body to create a fluid-type seal. The single seal/gasket design with a single sealing/compression plane is susceptible to leakage, as the single plane creates a pivot point about which the male end can rotate. Furthermore, the annular gasket itself, commonly known as a washer, can become brittle and less resilient with age. Some quick-connect couplings, such as push-pull ring or sliding sleeve connections, generally employ a more complicated mechanism with numerous parts requiring assembly that both increases its cost of production and decreases its reliability. Furthermore, the completed assembly is open to contamination further decreasing its reliability.

What is needed is an improved connection system that allows for fast and easy assembly and disassembly of the two mating hose bodies, while at the same time providing a more reliable, leak-resistant and stable connection between the two bodies.

### SUMMARY OF THE INVENTION

A general embodiment of the present invention provides a system for coupling an attachment and a hose. The system includes a flexible hose having an attachment end and a source end, a sleeve body connected to the attachment end of the hose, and an attachment having a mating body configured to enter an inner cavity of the sleeve body to form a joint with the sleeve body. The system further includes a locking mechanism to lock the mating body to the sleeve body, and a flow control mechanism oriented within the sleeve body and configured to variably adjust fluid flow through the system. A flow actuation member connected to the attachment is configured to engage the flow control mechanism to allow variable adjustment of fluid flow.

The present invention also provides a method of coupling a hose with an attachment, in which a mating body is inserted into a sleeve body. The sleeve body includes a flow control mechanism located in its inner cavity and is connected by its proximal end removably to the hose. The attachment includes a mating body configured to enter the inner cavity of the sleeve body through the distal end to form a joint with the sleeve body and to engage the flow control mechanism. The mating body is locked to the sleeve body by a locking mechanism.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a longitudinal section view of an assembled coupling in accordance with an embodiment of the present invention;

FIG. 2 is a longitudinal section view of the sleeve body of the coupling of FIG. 1;

FIG. 3A is a longitudinal section view of the mating body of the coupling of FIG. 1;

FIG. 3B is a front view of the mating body of the coupling of FIG. 1;

FIG. 4A is a front view of an unassembled flow control mechanism in accordance with a particular embodiment of the present invention;

FIG. 4B is a side longitudinal section view of the assembled flow control mechanism of FIG. 4A; and

FIG. 5 is a longitudinal section view of a connection of a supply end of a fluid transfer device to a fluid supply in accordance with an embodiment of the present invention.

It will be understood that these figures are not necessarily drawn to scale such that departure from relative dimensions, materials, structures and orientations can be had without departing from the spirit and scope of the following description and appended claims. Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

In describing embodiments of the present invention, the following terminology will be used.

The singular forms “a,” “an,” and “the” include plural referents unless the context clearly dictates otherwise. Thus, for example, reference to “a slot” includes reference to one or more of such features and “inserting” includes one or more of such steps.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As discussed above, conventional threaded couplings for hoses and related attachments or other fluid transfer devices are difficult to operate and prone to leakage. By eliminating the need for a threaded male/female connection this invention eliminates the many disadvantages of such a coupling. In addition, this invention as described herein provides a superior quick connect/disconnect function and an integral variable flow control valve that eliminates the need for separate valves.

The present invention generally provides leak-resistant threadless couplings, and more particularly threadless couplings that feature integration of coupling mechanisms with in-line flow control. Still more particularly, the invention provides a leak resistant threadless quick-connect for removably coupling a first fluid transfer device to a second fluid transfer device. The first fluid transfer device can be a garden hose, an industrial water hose, a faucet, a shut-off valve, a control valve, a section of rigid or flexible pipe, or other similar fluid transfer system. The second fluid transfer device can be a second hose, a nozzle, a section of rigid or flexible pipe, or other similar fluid transfer attachment.

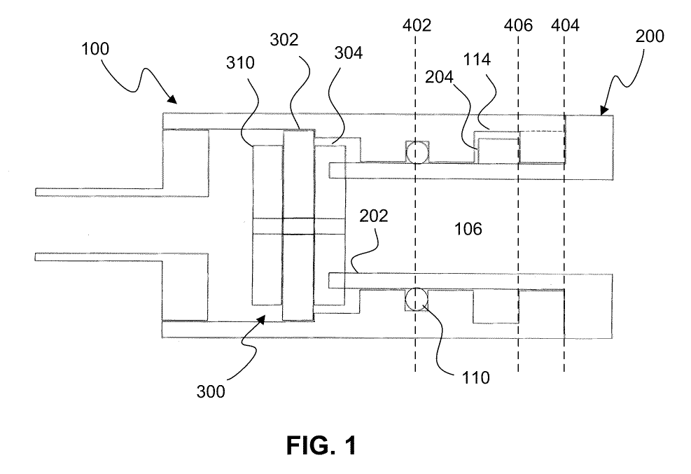

Illustrated in FIG. 1 is a coupling according to one embodiment of the present invention. FIG. 1 shows the coupling in its assembled state. The coupling generally comprises a sleeve body 100 (female) that can be connected to a fluid transfer device (e.g. a hose) and a mating body 200 (male) that that can be integrally connected to the other fluid transfer device (e.g. an attachment, not shown) and is configured to be inserted into the sleeve body. The coupling can further include a locking mechanism by which the two bodies are secured to each other, and a flow control mechanism for adjusting the flow of fluid through the devices. The embodiment depicted employs a bayonet-style connection interface to connect the two fluid transfer devices together. However, in alternative embodiments other connection types can be employed, such as locking rings, detent collar and groove types, wire bails, and spring clips.

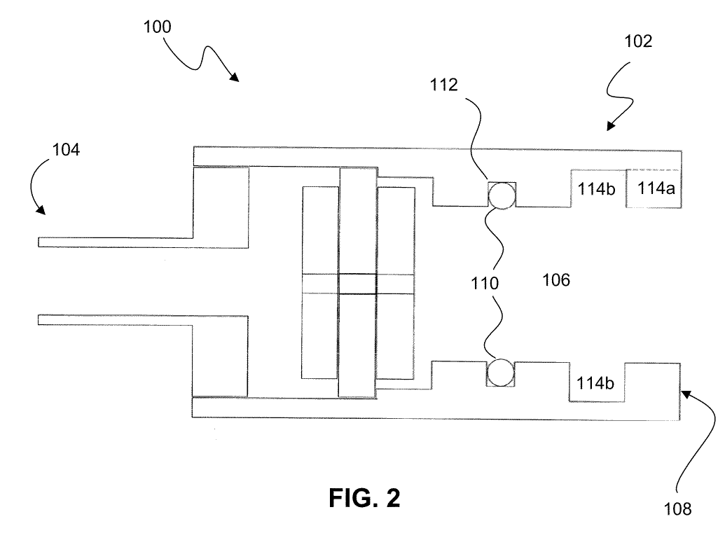

As discussed above, the female, outer sleeve body and male mating body can each be connected to a fluid transfer device and serve as a connection between the two fluid transfer devices. In a particular embodiment the sleeve body is connected to a flexible hose. In a more specific embodiment, the hose is a garden hose. Each body may be removably connected to its respective fluid transfer device, or alternatively, one or both bodies may each be an integral part of a device. As shown, the quick-connect of the present invention allows for fast and easy assembly and disassembly of the two coupling bodies, while maintaining a reliable, stable, and rigid connection between the sleeve body and the mating body to maintain a uniform contact between sealing surfaces. As shown in FIG. 2, the sleeve body 100 includes a proximal end 102, a distal end 104, and a cylindrical inner cavity 106. The proximal end of the sleeve body, opposite the end that couples or connects to the first fluid transfer device, can have an axial face 108 which can provide a meeting surface with a comparable meeting surface on the mating male body when the two embodiments are linked together.

The inner cavity 106 of the sleeve body can further include an elastomeric sealing element radially disposed therein so as to provide a leak-resistant seal. In a particular aspect, an example of which is illustrated in FIG. 2, the sealing element comprises an O-ring 110 or other annular sealing device. A radial groove 112 can be formed around the circumference of the inner cavity to receive and hold the O-ring in a fixed axial position near the distal end of the sleeve body. Glue, cement, or other adhesive can also be used in conjunction with or as a replacement for the circumferential groove, so that the sealing element is attached securely to the inside surface of the inner cavity to prevent it from moving during use.

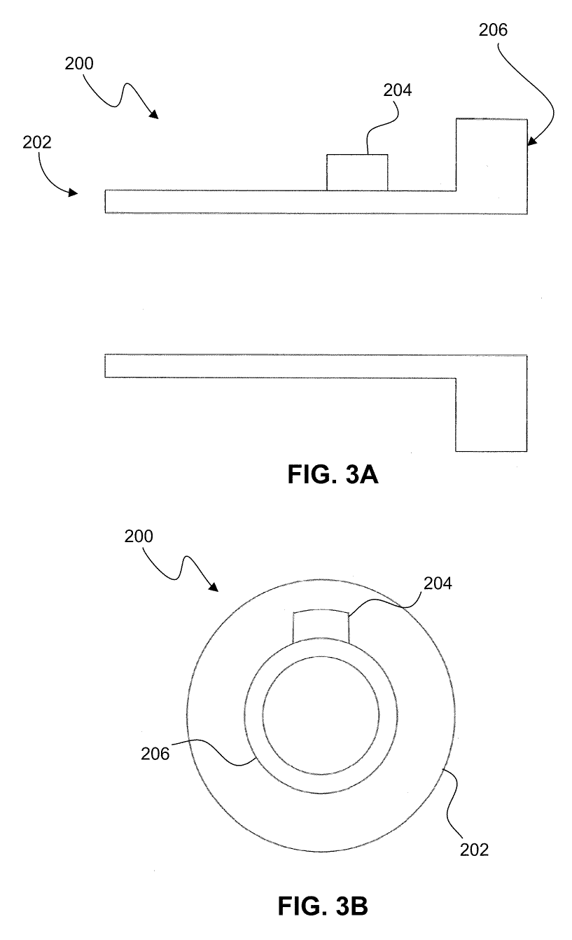

The coupling of the present invention further comprises a locking mechanism by which the sleeve body and the mating body are secured to one another. In the embodiment of the present invention shown in FIG. 2 and having a bayonet-type connection interface, the inner cavity 106 of the outer sleeve body 100 can have one or two receiving slots 114a and 114b formed in the proximal end thereof for providing a portion of the connection interface between the two bodies. As illustrated in FIG. 2, the receiving slot or slots can have an axial portion 114a which runs parallel to the centerline axis of the sleeve body, inside the inner cavity of the sleeve, and from the proximal face inwards to a connecting circumferentially oriented portion 114b which runs a specified radial distance to allow a projection (shown as 204 in FIG. 3A) from the mating body to rotate within the sleeve body. In a particular aspect, the circumferentially oriented section 114b can run a radial distance of from 40 to 355 degrees of arc, such as about 180 degrees. In another aspect, each end of a circumferentially oriented slot joins with an axial receiving slot so that a lug situated in the slot may be withdrawn at either end. In this manner, the hose can be left with the attachment disconnected in either an open flow or closed flow position.

Further illustrated in FIGS. 3A-3B is the male mating body 200 that can be coupled to a second fluid transfer device, such as an attachment. In one aspect, the mating body can have a stepped cylindrical outer surface divided into at least two sections: a smooth, smaller diameter sealing surface section 202 that is formed in the proximal end; one or two latching lugs 204 projecting from the intermediate middle section; and a distal section 206 having the same larger diameter as the outer female embodiment. In a more particular embodiment, this distal section can taper down to a diameter suitable for the integral attachment of the applicable fluid transfer appliance. In a more detailed embodiment, the mating body can include a middle section having a diameter intermediate to those of the proximal and distal sections. The distal section can be separated from the intermediate middle section by a projecting annular ring which can form a meeting surface similar to the meeting surface of the female embodiment. The attachment to the male mating body can optionally be integrally and permanently connected so as to avoid using a coupling which may leak. The attachment can be a spray nozzle, lawn sprinkler, or the like. Therefore, multiple attachment members can be provided so that a user can interchange the same according to use.

The quick-connect coupling can be removably coupled together by inserting the inner tubular body 100 into the outer sleeve body 200. As shown in FIG. 1 the receiving slot or slots 114 in the outer sleeve body can be configured to slidably receive a lug or lugs 204 projecting from the inner tubular body. During assembly, the lug or lugs can slide into the axially oriented portions 114a of the receiving slots as the tubular body is pushed into the sleeve body. Once the projecting lugs reach the end of the axially oriented portion, the tubular body and the sleeve body can be rotated one relative to the other, forcing the lug or lugs to travel through the circumferentially oriented portions of the receiving slot or slots.

During the insertion operation, the proximal sealing section 202 of the tubular body contacts the sealing element disposed inside the inner cavity 106 of the sleeve body 100. This contact forms a sealing plane. The sealing section can provide a smooth surface that is uniformly gripped by the elastomeric sealing element or elements, such as the single O-ring 110 or a pair of O-rings, to form a seal that prevents the passage of fluid along the outer surface of the tubular body thereby isolating the fluid from any contact with the outer portion of the assembly.

Thus, coupling the inner tubular body 200 with the outer sleeve body 100 can form three contact planes (illustrated in FIG. 1) which are perpendicular to the axis of the quick-connect coupling: the sealing contact plane 402, the meeting contact plane 404 and the lug-in-slot contact plane 406. The sealing planes are represented in FIG. 1 by dotted vertical lines. Unlike the prior art, in which the compression plane and the sealing plane are simultaneously formed with the same annular gasket, the present invention can provide for the three planes to be separated by a distance. Separating the sealing planes results in a more stable configuration, as the tubular body can no longer pivot about the combined sealing/compression plane provided by the single annular gasket or sealing member. Instead, in the present invention the moment arm created by the separated planes prevents wobble or radial movement of the tubular body within the sleeve body.

In an exemplary embodiment, one or two receiving slots 114 may be equally spaced around the inner circumference of the sleeve body 100, with the same number of projecting lugs 204 equally spaced around the outer circumference of the mating body. Furthermore, the sleeve body can include a plurality of circumferentially oriented slot sections, each being situated to accept one or more lugs so as to allow the inner body to rotate within the sleeve body. Thus, when removably coupling the mating body into the outer sleeve body, the projecting lugs slide into the receiving slots to provide a symmetrically aligned and balanced connection interface which serves to better position the mating body inside the sleeve body affording an even greater stability. When pushing the mating body into the outer sleeve body, to form a connection, the latching lug or lugs extending from the mating body slide through the axial section of the receiving slot of the outer inner body until reaching the circumferential section. The male body can then be rotated clockwise to join the two parts together. To disconnect the two parts, the procedure is reversed.

The present invention offers additional advantages over conventional quick-connect devices as the sealing element seals against the smooth, outer sidewalls of the mating body, and not the front axial face. This side-sealing can allow the mating body to slide in and out of the sleeve body during assembly, since the mating body moves both forward and backward as the projecting lugs move within the receiving slots. It is further advantageous because the radial sealing contact forces can be more uniform around the perimeter of the sealing surface than they would against an axial face.

In addition to eliminating the conventional troublesome screw type coupling of the fluid devices and providing a superior quick connect feature the present invention also provides smooth control of the fluid flow. In a particular aspect, a continuous range of flow rates from no flow to full flow are available. In another aspect, this control function is associated with the joint created by the coupling, and eliminates the need for a separate device or the inclusion of such a mechanism in each attachment.

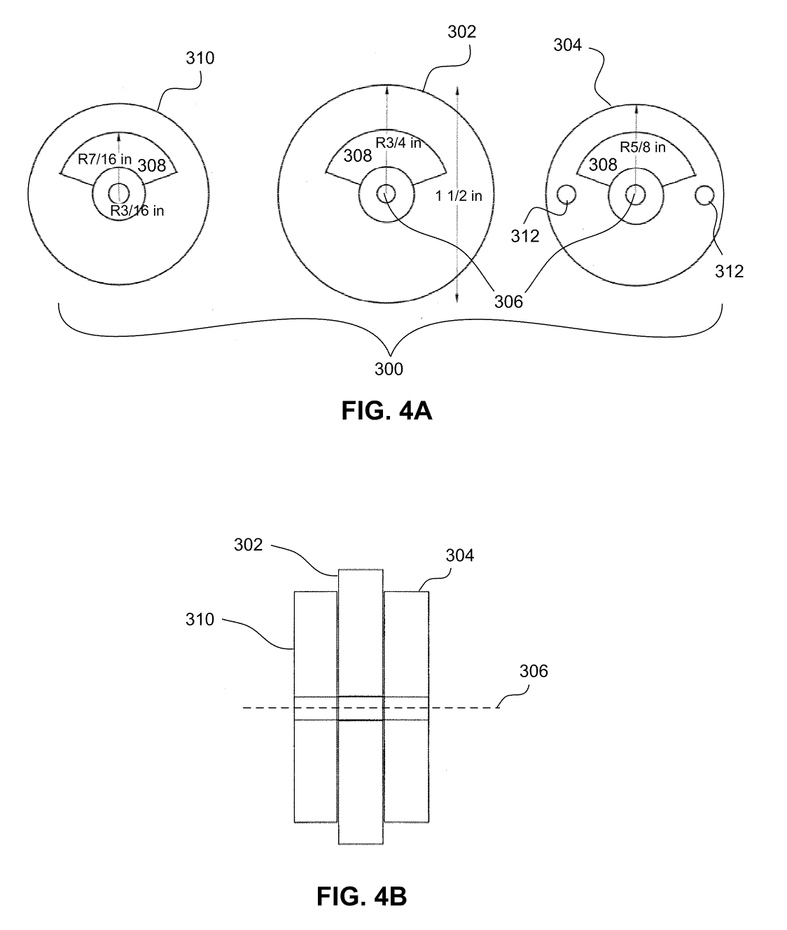

In particular embodiments (such as are illustrated in FIGS. 4A-4B), the fluid control mechanism 300 comprises at least two parallel flat disks 302, 304 that are situated adjacent to one another and which have a common axis 306 (perpendicular to the printed page). In a particular aspect, one disk is larger in diameter than the other. This is illustrated by the measurements provided in FIG. 4A. However, the actual measurement values shown are purely exemplary and are not intended to limit the possible dimensions of the embodiments described herein. In another aspect, one disk may be attached immovably to the inner cavity 106 of the sleeve body 100 (FIG. 1) and therefore prevented from rotating.

As illustrated in FIG. 4A, each disk is eccentrically penetrated by one or more apertures 308, so that when the apertures of both disks are in alignment fluid can flow through the disks. The rate of fluid flow depends on the degree of alignment. Thus a continuous range of flow rate is provided, from no flow when the apertures are completely unaligned to maximum flow when the apertures are completely aligned. In another embodiment, a third disk 310 having a third aperture may be connected through the common axis with the first disks. The third disk may be situated on the opposite side of the larger immobile disk from the first rotating disk, and may likewise rotate relative to the immobile disk. In a particular aspect the two rotating disks are fixed in their rotational alignment relative to one another.

The present invention also provides for integration of a flow control mechanism and the mating body. An embodiment of this arrangement is shown in FIGS. 1 and 3A. In accordance with this embodiment, the smaller disk 304 is configured to engage with the mating body when the mating body 200 is inserted into female sleeve body 100 to lock the two bodies together. This connection causes this disk to rotate relative to the larger disk 302 as the mating body is rotated within the sleeve body, thus controlling the amount of fluid flow. In a particular embodiment, the larger disk sits in an annular groove in the distal end of the sleeve body and is cemented or otherwise secured in place upon assembly so that it is prevented from rotating with the smaller disk. Connection between the male body and the smaller disk 304 may be made though one or more flow actuation members that are part of the male body. In a particular embodiment, the actuation members are nipples, equally spaced, projecting from the proximal end of the tubular inner body that slip into corresponding cavities 312 in the smaller disk when the male mating body is inserted into the female sleeve body or by other means such as slots in the proximal end of the inner body slipping over projections on the third disk.

In a particular embodiment, the receiving slots 114 and fluid control mechanism are aligned so that when the lugs 204 of the mating body 200 are in the receiving slots of the sleeve body 100 the apertures are out of alignment so that no fluid may flow. Only after the lugs enter the circumferentially oriented section 114b of the groove and move a predetermined distance in that groove do the openings in the two disks begin to line up to allow fluid flow. When the two bodies are disconnected and the lugs are withdrawn, the two disks automatically return to the closed position closing the fluid flow. In embodiments having a receiving slot at each end of a radial groove, the radial position of one of the receiving slots may correspond to the fully closed position of the fluid flow control while the other receiving slot may correspond to the fully open position. In this arrangement, the sleeve body can be either closed open to flow when not connected to the attachment and mating body.

It should be noted that the pressure of the fluid exerts a force between the small disk and the larger disk that prevents leakage between the surfaces of the two disks when the disks are not in alignment. The force also causes a frictional resistance of the one disk rotating relative to the other that prevents the lugs from turning too freely within the radial groove, thus preventing an inadvertent movement of the inner embodiment relative to the outer embodiment.

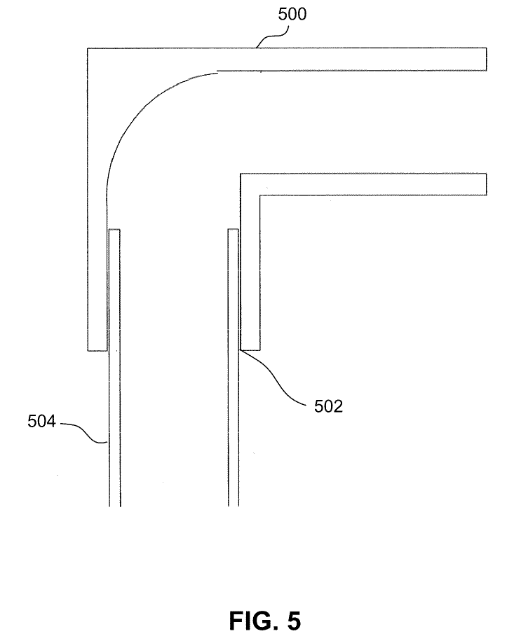

In a particular aspect of the invention, a system for fluid transfer can comprise the quick-connect coupling described herein as well as a supply line adapter 500 as shown in FIG. 5. The supply line adapter is configured to connect the coupling—either directly or via a fluid transfer device such as a hose—to a fluid source. In a particular embodiment, the adapter is configured to establish a fluid-tight connection 502 with a source such as a pipe 504. In a still more particular embodiment, this connection does not require screw threading. In another embodiment, the hose has the sleeve body 100 permanently attached to one end and the supply line adapter attached to the other end. This arrangement allows the total elimination of all screw connectors and washers from such a system.

Additional variations on the quick-connect of the present invention are possible and can be further advantageous. It is understood that for those wishing to retain their screw type hoses and attachments and still have the advantages of the quick connect and flow control of the present invention, the quick connect could be supplied with the conventional screw connector on either or both ends.

Of course, it is to be understood that the above-described arrangements, and specific examples and uses, are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein. Accordingly, it is not intended that the invention be limited, except as by the claims set forth below.

What is claimed is:

1. A system for coupling an attachment and a hose, comprising:
a) a flexible hose having an attachment end and a source end;
b) a sleeve body having a proximal end, a distal end, and an inner cavity, wherein the proximal end is connected to the attachment end of the hose;
c) an attachment having a mating body configured to enter the inner cavity through the distal end to form a joint with the sleeve body;
d) a locking mechanism to lock the mating body to the sleeve body; and
e) a flow control mechanism oriented within the sleeve body and configured to variably adjust fluid flow through the system, said locking mechanism including a flow actuation member connected to the mating body and configured to engage the flow control mechanism to allow variable adjustment of fluid flow.

2. The system of claim 1, wherein the locking mechanism is a member selected from the group consisting of bayonet-type coupling, locking ring, detent collar and groove, wire bail, and spring clip.

3. The system of claim 2, wherein the locking mechanism is a bayonet-type coupling comprising:
a lug projecting from the mating body; and
a receiving slot in the inner cavity, said receiving slot having an axially-oriented section configured to slidably receive the lug, and a circumferentially oriented section configured to permit rotation of the mating body within the inner cavity.

4. The system of claim 3, wherein the circumferentially oriented section extends around the inner cavity for about 40 to about 355 degrees of arc.

5. The system of claim 3, wherein the receiving slot includes an axially oriented section at either end of the circumferentially oriented section.

6. The system of claim 1, wherein the flow control mechanism is located at the joint.

7. The system of claim 1, wherein the flow control mechanism comprises
a) a first disk, penetrated centrally by an axis and eccentrically by a first aperture, and immovably attached to the inner cavity; and
b) a second disk adjacent and parallel to the first disk, penetrated centrally by the axis and eccentrically by a second aperture, and capable of rotating around the axis relative to the first disk,
wherein degree of alignment of the first aperture and second aperture permits selectively variable fluid flow through the flow control mechanism.

8. The system of claim 7, wherein the flow actuation member is configured to engage the second disk when the mating body is locked to the sleeve body, so as to transmit rotation of the mating body to the second disk.

9 The system of claim 7, further comprising a third disk adjacent and parallel to the first disk and opposite the second disk, penetrated centrally by the axis and eccentrically by a third aperture substantially aligned with the second aperture, and capable of rotating around the axis relative to the first disk.

10. The system of claim 1, further comprising one or more seals oriented at interfaces between the attachment and the sleeve body.

11. The system of claim 10, wherein the one or more seals includes an O-ring located in the inner cavity and away from the joint between the inner cavity and the mating body.

12. The system of claim 1, wherein the proximal end is removably connected to the attachment end of the hose.

13. The system of claim 1, wherein the hose is a garden hose.

14. The system of claim 1, wherein the mating body is removably connected to the attachment.

15. A method of coupling a hose with an attachment, comprising:
a) providing a sleeve body having a proximal end, a distal end, an inner cavity, and a flow control mechanism located in the inner cavity;
b) connecting the proximal end removably to the hose;
c) providing an attachment having a mating body configured to enter the inner cavity through the distal end to form a joint with the sleeve body and to engage the flow control mechanism;
d) inserting the mating body into the inner cavity; and
e) locking the mating body to the sleeve body by a locking mechanism.

16. The method of claim 15, wherein the flow control mechanism comprises
a) a first disk, penetrated centrally by an axis and eccentrically by a first aperture, and immovably attached to the inner cavity; and
b) a second disk, penetrated centrally by the axis and eccentrically by a second aperture, and capable of rotating around the axis relative to the first disk, and
wherein flow of a fluid through the flow control mechanism is controlled by rotating the second disk so as to modify alignment of the first aperture with the second aperture.

17. The method of claim 15, further comprising operating the flow control mechanism by moving the mating body within the sleeve body.

18. The method of claim 17, wherein moving the mating body within the sleeve body comprises rotating the mating body.

19. The method of claim 16, wherein locking the mating body to the sleeve body comprises rotating the mating body.
